(19) United States
(12) Patent Application Publication
(10) Pub. No.: US 2026/0277306 A1
(43) Pub. Date: Sep. 17, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Yu TSUMURAYA, Tokyo (JP); Yusuke MORI, Tokyo (JP); Akio YOSHIOKA, Tokyo (JP); Sayo MINOWA, Tokyo (JP); Masatoshi FURUKAWA, Tokyo (JP)

(73) Assignee: NEC Corporation, Tokyo (JP)

(21) Appl. No.: 19/539,166

(22) Filed: Feb. 13, 2026

(30) Foreign Application Priority Data
Mar. 12, 2025 (JP) 2025-039581

(51) Int. Cl. G06F 3/01; G06F 3/03; G06F 3/0482; G06F 3/04845; G06F 21/32; G06T 7/73; G06V 40/10

(52) U.S. Cl. CPC G06F 3/011; G06F 3/017; G06F 3/0325; G06F 3/0482; G06F 3/04845; G06F 21/32; G06T 7/73; G06V 40/10

(57) ABSTRACT

An information processing apparatus includes an acquisition unit that acquires feature information about a hand or arm, from a captured image of a hand or arm obtained by an imaging unit of a head-mounted display, a calculation unit that calculates a matching degree between feature information about a hand or arm of a user of the head-mounted display registered in advance and the acquired feature information acquired by the acquisition unit, and a determination unit that performs a first determination operation of determining, based on the matching degree, whether or not the hand or arm in the captured image is the hand or arm of the user.

### INCORPORATION BY REFERENCE

This application is based upon and claims the benefit of priority from Japanese Patent Application No. 2025-039581, filed on Mar. 12, 2025, the disclosure of which is incorporated herein in its entirety by reference.

### TECHNICAL FIELD

Example embodiments of a present disclosure relate to an information processing apparatus, an information processing method, and a non-transitory recording medium.

### BACKGROUND ART

A known apparatus of this type receives/accepts an operation based on a user's movement (i.e., a gesture operations). For example, International Publication No. WO 2024/185330 discloses a technology/technique of receiving an operation input based on a user's hand movement when using a head-mounted display.

However, the user's hand recognized in the gesture operation is not limited to the user's own hand, but may be another person's hand. Consequently, an unintended operation may be performed when another person is nearby, which is technically problematic.

### SUMMARY

In light of the aforementioned technical issues, it is an example object of the present disclosure to provide an information processing apparatus, an information processing method, and a non-transitory recording medium that reduce the possibility of the unintended operation by the user.

An information processing apparatus according to an example aspect of the present disclosure includes: an acquisition unit that acquires feature information about a hand or arm, from a captured image of a hand or arm obtained by an imaging unit of a head-mounted display; a calculation unit that calculates a matching degree between the feature information about a hand or arm of a user of the head-mounted display registered in advance and the feature information acquired by the acquisition unit; and a determination unit that performs a first determination operation of determining, based on the matching degree, whether or not the hand or arm in the captured image is the hand or arm of the user.

An information processing method according to an example aspect of the present disclosure is an information processing method that is executed by at least one computer, the information processing method including: acquiring feature information about a hand or arm, from a captured image of a hand or arm obtained by an imaging unit of a head-mounted display; calculating a matching degree between the feature information about a hand or arm of a user of the head-mounted display registered in advance and the feature information acquired; and performing a first determination operation of determining, based on the matching degree, whether or not the hand or arm in the captured image is the hand or arm of the user.

A non-transitory recording medium according to an example aspect of the present disclosure is a non-transitory recording medium on which a computer program that allows at least one computer to execute an information processing method is recorded, the information processing method including: acquiring feature information about a hand or arm, from a captured image of a hand or arm obtained by an imaging unit of a head-mounted display; calculating a matching degree between the feature information about a hand or arm of a user of the head-mounted display registered in advance and the feature information acquired; and performing a first determination operation of determining, based on the matching degree, whether or not the hand or arm in the captured image is the hand or arm of the user.

### BRIEF DESCRIPTION OF THE DRAWINGS

FIG. 1 is a block diagram illustrating a hardware configuration of a first information processing apparatus;

FIG. 2 is a block diagram illustrating a functional configuration of the first information processing apparatus;

FIG. 3 is a flowchart illustrating a flow of operation in the first information processing apparatus;

FIG. 4 is a block diagram illustrating a functional configuration of a second information processing apparatus;

FIG. 5 is a block diagram illustrating a functional configuration of a third information processing apparatus;

FIG. 6 is a block diagram illustrating a functional configuration of a fourth information processing apparatus;

FIG. 7 is a block diagram illustrating a functional configuration of a fifth information processing apparatus;

FIG. 8 is a flowchart illustrating a flow of a user data registration operation by the fifth information processing apparatus;

FIG. 9 is a block diagram illustrating a functional configuration of a sixth information processing apparatus; and

FIG. 10 is a flowchart illustrating a flow of operation in the sixth information processing apparatus.

### EXAMPLE EMBODIMENTS

Hereinafter, an information processing apparatus, an information processing method, a computer program, and a recording medium according to example embodiments will be described with reference to the drawings.

### First Example Embodiment

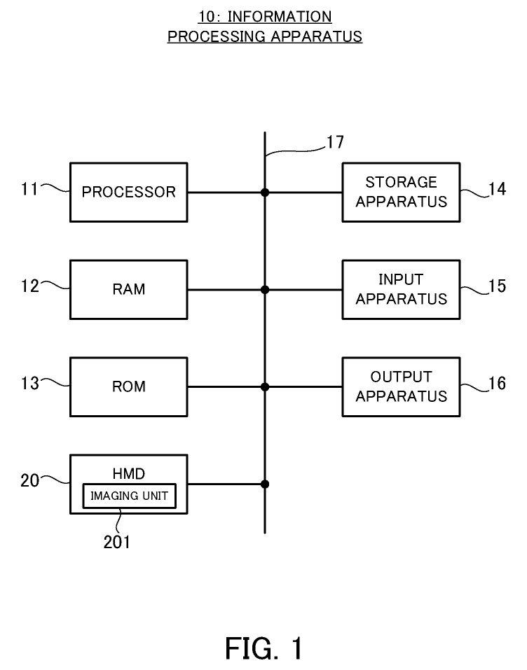

A first information processing apparatus will be described with reference to FIGS. 1 to 3.

### Hardware Configuration

First, a hardware configuration of the first information processing apparatus will be described with reference to FIG. 1. FIG. 1 is a block diagram illustrating the hardware configuration of the first information processing apparatus.

As illustrated in FIG. 1, a first information processing apparatus 10 includes a processor 11, a RAM (Random Access Memory) 12, a ROM (Read-Only Memory) 13, a storage apparatus 14, an input apparatus 15, an output apparatus 16, and a head-mounted display (hereinafter referred to as a “HMD”). The processor 11, the RAM 12, the ROM 13, the storage apparatus 14, the input apparatus 15, the output apparatus 16, and the HMD 20 are connected via a data bus 17. The data bus 17 may be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may acquire (i.e., read) a computer program from a not-illustrated apparatus disposed outside the first information processing apparatus 10 via a network interface. The processor 11 performs various types of processing by executing the read computer program. When the processor 11 executes the read computer program, a function block related to processing to be performed by the first information processing apparatus 10 is realized in the processor 11. That is, the processor 11 may function as a controller that performs each control in the first information processing apparatus 10.

The processor 11 may be configured as, for example, a CPU (Central Processing Unit), a GPU (Graphics Processing Unit), a FPGA (Field-Programmable Gate Array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by the processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the first information processing apparatus 10 for a long time. The storage apparatus 14 may operate as a transitory storage apparatus of the processor 11. The storage apparatus 14 may store the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the first information processing apparatus 10. The input apparatus 15 may include, for example, at least one of a keyboard, a mouse, a touch panel, and a touch pen. The input apparatus 15 may be an apparatus that allows audio input/voice input, including a microphone, for example.

The output apparatus 16 is an apparatus that outputs information about the first information processing apparatus 10 to the outside. For example, the output apparatus 16 may be a display apparatus (e.g., a display, a monitor, etc.) that is configured to display the information about the first information processing apparatus 10. The output apparatus 16 may also be a speaker that audio-outputs the information about the first information processing apparatus 10, or the like.

The HMD 20 is a display apparatus worn on the user's head, displaying images within the user's field of view. The HMD 20 includes an imaging unit 201. The imaging unit 201 may be, for example, a camera mounted on a housing part of the HMD 20, and may be configured to capture an image corresponding to the field of view of the user wearing the HMD 20. A plurality of imaging units 201 may be provided for a single HMD 20. The imaging unit 201 may be, for example, an RGB camera equipped with a wide-angle lens, a depth camera, or the like.

The first information processing apparatus 10 may include only a part of the components described in FIG. 1. For example, the first information processing apparatus 10 may include only the processor 11, the RAM 12, and the ROM 13, among the aforementioned components. In this case, each of the storage apparatus 14, the input apparatus 15, the output apparatus 16, and the HMD 20 may be provided as an apparatus external to the first information processing apparatus 10. Furthermore, a part of an arithmetic/computational function of the first information processing apparatus 10 may be realized by an external server, a cloud, or the like.

### Functional Configuration

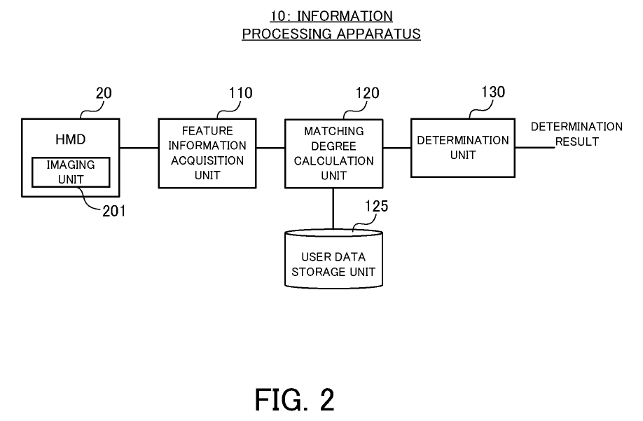

Next, with reference to FIG. 2, a functional configuration of the first information processing apparatus 10 will be described. FIG. 2 is a block diagram illustrating the functional configuration of the first information processing apparatus.

In FIG. 2, the first information processing apparatus 10 is configured as an apparatus that determines whether a hand or an arm captured by the HMD 20 belongs to the user themselves. The first information processing apparatus 10 includes, as components for realizing its functions, in addition to the aforementioned HMD 20, a feature information acquisition unit 110, a matching degree calculation unit 120, a user data storage unit 125, and a determination unit 130. Each of the feature information acquisition unit 110, the matching degree calculation unit 120, and the determination unit 130 may be a processing block realized by the aforementioned processor 11 (see FIG. 1). Furthermore, the user data storage unit 125 may be realized by the aforementioned storage apparatus 14 (see FIG. 1). The user data storage unit 125 may be a storage apparatus provided externally to the first information processing apparatus.

The feature information acquisition unit 110, the matching degree calculation unit 120, the user data storage unit 125, and the determination unit 130 may be components included in a control apparatus separate from the HMD 20. Alternatively, the feature information acquisition unit 110, the matching degree calculation unit 120, the user data storage unit 125, and the determination unit 130 may be integrally configured with the HMD 20. In this case, miniaturization of the entire apparatus and high-speed processing can be achieved.

The feature information acquisition unit 110 extracts feature information about the hand or arm, from an image (hereinafter referred to as a “captured image” as appropriate) captured by the imaging unit 201 in the HMD 20. The feature information acquisition unit 110 may, for example, use image processing software to extract the feature information about the hand or arm from the captured image. In a case where the captured image contains a plurality of hands or arms, the feature information acquisition unit 110 may acquire the feature information for each of them. The feature information about the hand or arm acquired by the feature information acquisition unit 110 (hereinafter referred to as “acquired feature information”) is configured to be outputted to the matching degree calculation unit 120.

The matching degree calculation unit 120 is configured to calculate a matching degree between the acquired feature information obtained by the feature information acquisition unit 110 and the feature information about the hand or arm of the user of the head-mounted display registered in advance (hereinafter referred to as “registered feature information” as appropriate). The matching degree calculation unit 120 reads the registered feature information from the user data storage unit 125 and calculates the matching degree with the acquired feature information. The matching degree calculation unit 120 may calculate the matching degree, for example, using an algorithm prepared in advance. Information about the matching degree calculated by the matching degree calculation unit 120 is configured to be outputted to the determination unit 130.

The determination unit 130 is configured to determine, based on the matching degree calculated by the matching degree calculation unit 120, whether or not the hand or arm in the captured image belongs to a user of the HMD 20 (i.e., a person actually wearing and using the HMD 20). Hereinafter, this determination operation based on the matching degree will be referred to as a “first determination operation” as appropriate. A determination result of the first determination operation is used when an operation input for the HMD 20 is received. For example, in a case where the hand or arm in the captured image is determined to belong to the user, a gesture made by the hand or arm in the captured image may be accepted as the operation input for the HMD 20. Conversely, in a case where the hand or arm in the captured image is determined not to belong to the user, the gesture made by the hand or arm in the captured image may be rejected as the operation input for the HMD20.

### Flow of Operation

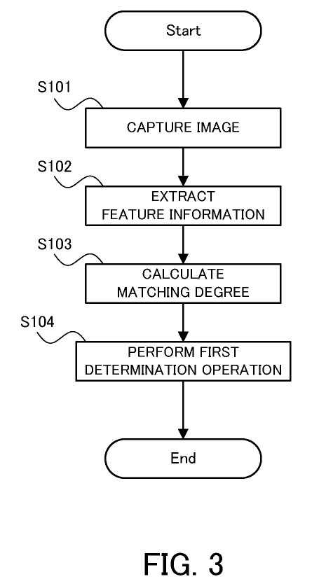

Next, with reference to FIG. 3, a flow of operation in the first information processing apparatus 10 will be described. FIG. 3 is a flowchart illustrating the flow of operation in the first information processing apparatus.

As illustrated in FIG. 3, when the operation of the first information processing apparatus 10 is started, the imaging unit 201 in the HMD 20 first captures an image (Step S101). The imaging unit 201 may continuously capture images of the hand or arm within the user's field of view.

Then, the feature information acquisition unit 110 extracts the feature information about the hand or arm, from the captured image obtained by the imaging unit 201 (Step S102). The feature information acquisition unit 110 may use image processing software to extract the feature information such as the contour, shape, texture or the like of the hand or arm contained in the captured image.

Then, the matching degree calculation unit 120 calculates the matching degree between the acquired feature information obtained by the feature information acquisition unit 110 and the registered feature information read from the user data storage unit 125 (Step S103). For example, the matching degree calculation unit 120 may perform processing of quantifying a degree of similarity between the acquired feature information and the registered feature information.

Then, the determination unit 130 performs the first determination operation (step S104). That is, the determination unit 130 determines whether or not the hand or arm in the captured image belongs to the user of the HMD 20, based on the matching degree calculated by the matching degree calculation unit 120. The determination unit 130 may determine that the hand or arm in the captured image belongs to the user in a case where the matching degree calculated by the matching degree calculation unit 120 is greater than or equal to a preset threshold. The determination unit 130 may determine that the hand or arm in the captured image does not belong to the user in a case where the matching degree calculated by the matching degree calculation unit 120 is less than the preset threshold.

### Technical Effect

Next, a technical effect obtained by the first information processing apparatus 10 will be described.

As described in FIG. 1 to FIG. 3, in the first information processing apparatus 10, whether or not the hand or arm in the captured image belongs to the user of the HMD 20 is determined based on the matching degree between the acquired feature information extracted from the captured image and the registered feature information registered in advance. This reduces the possibility of an unintended operation input for the HMD 20 by the hand or arm of another person (i.e., a person other than the user of the HMD 20). Consequently, reliability and safety of HMD operation are enhanced, improving user experience.

Furthermore, in the present example embodiment, the feature information about the hand or arm is extracted from the captured image, and the matching degree is calculated between that feature information and the user’s feature information registered in advance, thereby enabling highly accurate determination. This reduces the risk of erroneous determination, enabling more reliable identification of the user's own hand or arm.

The first information processing apparatus 10 may perform additional operations to realize the present disclosure in the following situations.

First, in a case where the user is wearing gloves, the feature information acquisition unit 110 may fail to accurately extract the feature information about the hand or arm. In this case, the matching degree calculation unit 120 may fail to calculate an accurate matching degree, and the determination unit 130 may make an erroneous determination.

In contrast, the first information processing apparatus 10 may add the following operation. The feature information acquisition unit 110 has a function of detecting the presence of gloves. In a case where the gloves are detected, the feature information acquisition unit 110 extracts a feature/characteristic of the gloves (e.g., a color, a pattern, a shape, etc.) as the feature information. Furthermore, the user of the HMD 20 registers the feature information for a plurality of states (e.g., bare hands, wearing various types of gloves, etc.) in advance. This enables accurate determination even when the user is wearing gloves.

Second, in a case where there is a temporary change in the user's hand or arm (e.g., injury, suntan/sunburn, etc.), there may arise a significant difference from the registered feature information. In such a case, the determination unit 130 may erroneously determine the user's hand or arm to be another person’s hand or arm.

In contrast, the first information processing apparatus 10 may add the following operation. In a case where the determination result continuously indicates “another person's hand or arm” for a certain period, the determination unit 130 displays an indication requesting confirmation from the user. When the user confirms that it is their own hand or arm, processing of updating the feature information is performed. In this way, it is possible to respond even the temporary change in the user's hand or arm.

Third, in an environment where many people are working in close proximity, another person's hand or arm may be frequently captured. In this case, a system's processing load may increase, potentially reducing a response speed.

In contrast, the first information processing apparatus 10 may add the following operation. The imaging unit 201 uses a depth sensor to capture only hands or arms within a certain distance range. Furthermore, in a case where it is determined to be the “user's hand or arm” by the first determination operation immediately before or within a predetermined time, the determination unit 130 performs simplified determination (e.g., checking position continuity, etc.) in the next frame, instead of the first determination operation. A second determination operation described later may also be applied as this simplified determination. This enables high-speed and stable determination, while reducing the processing load.

In the first information processing apparatus 10, the components may be replaced as follows.

The imaging unit 201 may not be limited to a single camera, which may be replaced with a stereo camera system including a combination of a plurality of cameras. This makes it possible to acquire three-dimensional shape information about the hand or arm, and to extract more precise feature information.

The image processing software in the feature information acquisition unit 110 may be replaced with a feature extraction algorithm using a machine learning model (e.g., a convolutional neural network). This enables the extraction of more complex and subtle features, potentially improving determination accuracy.

For the calculation of the matching degree in the matching degree calculation unit 120, various similarity calculation methods such as cosine similarity and normalized cross-correlation, may be used. For example, it is possible to select an optimal method according to a usage environment and required accuracy.

The determination unit 130 may not be limited to simple determination based on a threshold, which may be replaced with a determination device using a machine learning model (e.g., support vector machine, a random forest, etc.). This enables comprehensive evaluation of a plurality of features and more advanced determination.

These replacements enable the realization of a more accurate, flexible, hand or arm recognition system, while maintaining fundamental effects of the present example embodiment.

### Second Example Embodiment

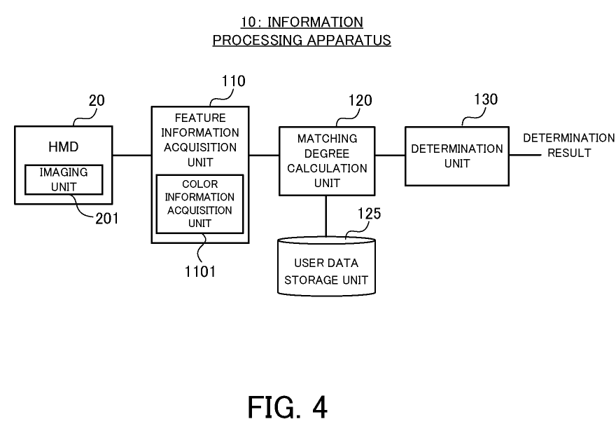

A second information processing apparatus 10 will be described with reference to FIG. 4. Note that the second information processing apparatus 10 partially differs from the first information processing apparatus 10 described above in its configuration and operation, and may be the same as the first information processing apparatus 10 in the other parts. Therefore, the following description details only parts differing from the first example embodiment, omitting a redundant description for other overlapping parts as appropriate.

### Functional Configuration

First, with reference to FIG. 4, a functional configuration of the second information processing apparatus 10 will be described. FIG. 4 is a block diagram illustrating the functional configuration of the second information processing apparatus. Note that in FIG. 4, the same reference numerals are used for the same components as those illustrated in FIG. 2.

In FIG. 4, the second information processing apparatus 10 includes, as components for realizing its functions, the HMD 20, the feature information acquisition unit 110, the matching degree calculation unit 120, the user data storage unit 125, and the determination unit 130. Especially, the feature information acquisition unit 110 in the second information processing apparatus 10 includes a color information acquisition unit 1101.

The color information acquisition unit 1101 is configured to acquire information about a color of the hand or arm from the captured image obtained by the imaging unit 201. The feature information acquisition unit 110 acquires the information about the color of the hand or arm acquired by the color information acquisition unit 1101, as the feature information about the hand or arm. The color information acquisition unit 1101 may perform image processing on the captured image to identify an area of the hand or arm, and may extract the color information from that area. For the extraction of the color information, for example, a color analysis algorithm using the HSV color space or Lab color space may be used.

### Technical Effect

Next, a technical effect obtained by the second information processing apparatus 10 will be described.

As described in FIG. 4, in the second information processing apparatus 10, the color information about the hand or arm in the captured image is acquired as the feature information. This enables high-speed and accurate determination of whether the hand or arm belongs to the user themselves, using the color information about the hand or arm, which is a simple yet effective feature.

More specifically, first, the use of the color information about the hand or arm as the feature information makes it possible to simply and quickly acquire information effective for personal identification. The color information is a feature/characteristic that varies from person to person, and is data that are easily extractable through image processing. Therefore, it enables high-speed determination processing without requiring complex feature extraction processing.

Second, the method in the present example embodiment does not require the user to wear a special apparatus or marker (e.g., special gloves or identification marker). Since the determination is possible with the user’s hand or arm in a natural state, security can be enhanced without compromising usability.

Third, the use of the color information makes it possible to maintain a certain level of determination accuracy even if a state of wearing gloves or accessories changes. By utilizing the color information from an exposed skin part, it is possible to adapt these changes.

Through the above effects, the second information processing apparatus 10 is capable of maintaining user convenience, while enhancing operational security of the HMD 20 in use. This enables the provision of a safer and more comfortable operating environment in various applications and services utilizing the HMD 20.

The second information processing apparatus 10 may perform additional operations to realize the present disclosure in the following situations.

First, when it is used under extreme lighting conditions, in some cases, it is hard to obtain accurate color information. For example, in a very dark environment, or conversely, under strong direct sunlight, the color information in images captured by the camera may be significantly distorted.

Second, in a case where the user is wearing gloves, the feature information acquisition unit 110 may fail to accurately extract the color information about the hand or arm. In this case, the matching degree calculation unit 120 may fail to calculate an accurate matching degree, potentially leading to erroneous determination by the determination unit 130.

Third, in a case where the user's skin color significantly changes due to suntan/sunburn, makeup, or the like, a match degree with the color information registered in advance may decrease, potentially causing erroneous determination.

To address these issues, the second information processing apparatus 10 may add the following operations.

Added for the issue of the lighting conditions, is processing of detecting a lighting condition(s) using an ambient light sensor mounted on the HMD 20 and performing color correction on the captured image. This enables stable acquisition of the color information under various lighting conditions.

Added for the issue when the user is wearing gloves, is a function of analyzing a feature/characteristic other than the color information (e.g., hand shape or movement).

Added for the issue of the skin color change, is a function of periodically updating the color information. For example, an applicable method is re-registering the color information with user confirmation at regular intervals, or gradually updating the color information during daily use, or the like.

These additional operations make it possible to maintain the effectiveness and reliability of the second information processing apparatus 10 even in various usage environments and situations.

In the second information processing apparatus 10, the components may be replaced as follows.

First, regarding the imaging unit 201, an infrared camera may be used, instead of a conventional RGB camera. The use of an infrared camera enables stable image acquisition less affected by visible light, and enables more robust determination against a change in the lighting conditions.

Next, regarding the feature information acquisition unit 110, a dedicated hardware processor may be used, instead of software-based image processing. For example, the use of an FPGA (Field-Programmable Gate Array) or an ASIC (Application Specific Integrated Circuit) specialized for the extraction of the color information, expectedly improves processing speed and reduces power consumption.

Regarding the matching degree calculation unit 120, a machine learning model, especially a method using deep learning, may be used, instead of a conventional numerical calculation algorithm. The use of a neural network trained/learned in advance with a large amount of image data about the hand or arm, enables more accurate and flexible similarity calculation.

Regarding the determination unit 130, a probabilistic method such as fuzzy logic or Bayesian estimation may be introduced, instead of determination based on a single threshold. This enables more flexible, situation-specific determination, and reduces the risk of erroneous determination.

These replacements expectedly enhance the performance of the second information processing apparatus 10, expand its usage environments, and even open up new application fields. However, when making each replacement, it is desirable to fully consider trade-offs such as cost, power consumption, and processing speed.

### Third Example Embodiment

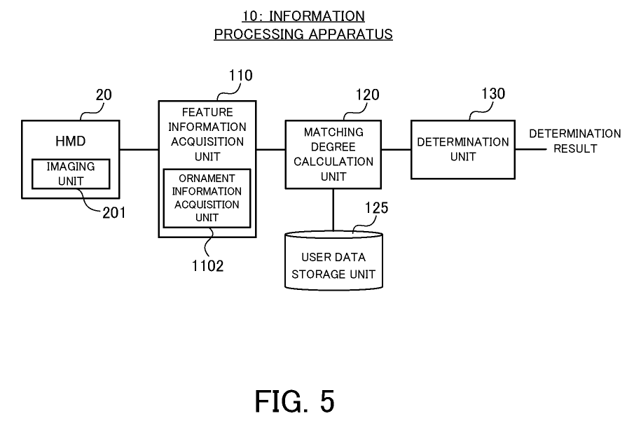

A third information processing apparatus 10 will be described with reference to FIG. 5. The third information processing apparatus 10 partially differs from the first and second information processing apparatuses 10 described above in its configuration and operation, and may be the same as the first and second information processing apparatuses 10 in the other parts. Therefore, the following description details only parts differing from the already described example embodiments, omitting a redundant description for other overlapping parts as appropriate.

### Functional Configuration

First, with reference to FIG. 5, a functional configuration of the third information processing apparatus 10 will be described. FIG. 5 is a block diagram illustrating the functional configuration of the third information processing apparatus. In FIG. 5, the same reference numerals are used for the same components as those illustrated in FIG. 2.

In FIG. 5, the third information processing apparatus 10 includes, as components for realizing its functions, the HMD 20, the feature information acquisition apparatus 110, the matching degree calculation apparatus 120, the user data storage apparatus 125, and the determination apparatus 130. Especially, the feature information acquisition apparatus 110 in the third information processing apparatus 10 includes an ornament information acquisition apparatus 1102.

The ornament information acquisition unit 1102 is configured to acquire information about an ornament worn on a hand or arm from the captured image obtained by the imaging unit 201. The feature information acquisition unit 110 acquires the information about the ornament worn on the hand or arm acquired by the ornament information acquisition unit 1102, as the feature information about the hand or arm. The ornament information acquisition unit 1102 may perform image processing on the captured image to detect an ornament such as a ring, a watch, and a bracelet worn on the hand or arm, and extract a feature/characteristic such as its shape, color, and position.

### Technical Effect

Next, a technical effect obtained by the second information processing apparatus 10 will be described.

As described in FIG. 5, in the third information processing apparatus 10, the information about the ornament worn on the hand or arm in the captured image is acquired as the feature information. This enables high-speed and accurate determination of whether the hand or arm belongs to the user themselves, using the information about the ornament worn on the hand or arm, which is a simple yet effective feature.

More specifically, first, the use of the ornament worn on the hand or arm as the feature information allows a more highly personal feature/characteristic to be used as a determination criterion. The ornament reflects personal preferences and habits, making it a more distinctive feature/characteristic for identifying an individual than the shape or color of the hand or arm. This enables the identification of the user's own hand or arm with higher accuracy.

Second, the use of the combination and arrangement of ornaments as the feature information, makes is possible to establish a more complex and difficult-to-imitate determination criterion. For example, by using a relative positional relation between a plurality of ornaments, such as a combination of a ring on the left ring finger and a watch on the right wrist, as the determination criterion, it is possible to extremely reduce a possibility that another person coincidentally satisfies the same conditions.

As described above, the third information processing apparatus 10 achieves highly accurate and stable user authentication by utilizing an ornament as the feature information, significantly enhancing the operational security of the HMD 20.

The third information processing apparatus 10 may perform additional operations to realize the present disclosure in the following situations.

First, there may be a case where the user removes their ornament that they usually wear, before using the HMD 20. For example, in a state in which the user is not wearing a ring or a watch when the user uses the HMD 20 before bathing or sleeping, the system may fail to correctly recognize the user.

Additionally, in a case where the user puts on a new ornament or changes the position of the ornament (e.g., puts a ring on a different finger), the system may also fail to correctly recognize the user.

Furthermore, a case where the ornament is hidden due to wearing items like gloves or a supporter, may also interfere with the normal operation of the system.

To address these issues, the third information processing apparatus 10 performs the following operations.

First, the third information processing apparatus 10 performs the determination by combining a plurality of pieces of feature information. By analyzing not only the feature/characteristic of the ornament, but also the shape, color, and movement pattern of the hand or arm, it is possible to perform accurate determination, even if a part of the feature/characteristic is missing.

Second, the third information processing apparatus 10 learns the user's habits and dynamically adjusts the determination criterion according to the situation. For example, in a case where the user tends to remove the ornament at night, other features/characteristics may be focused for the determination during that time period.

Third, in a case where the feature/characteristic of the ornament cannot be detected, the third information processing apparatus 10 requests the user for confirmation. For example, provided is an alternative authentication method, such as voice-based identity verification or requesting password entry.

Fourth, the third information processing apparatus 10 periodically prompts the user to update the feature information. In a case where there is a change in the user's ornament usage status, it allows new feature information to be registered with a simple operation.

These measures maintain the effects of the present disclosure under various circumstances, enabling stable user authentication.

In the third information processing apparatus 10, the components may be replaced as follows.

The imaging unit 201 may not be limited to a single camera, which may be replaced with a stereo camera system combining a plurality of cameras or a 3D camera incorporating a depth sensor. This makes it possible to more accurately understand the three-dimensional shape and position of the ornament.

The feature information acquisition unit 110 may incorporate a machine learning model, in addition to image processing software. For example, the use of a convolutional neural network (CNN) makes it possible to improve detection accuracy of the ornament, and to recognize a more complex decorative pattern.

The matching degree calculation unit 120 may incorporate not only simple feature comparison, but also fuzzy logic or a probabilistic model. This enables flexible adaptation to a subtle change in the ornament or its positional deviation, and enables more flexible calculation of the matching degree, which is closer to human determination.

The determination unit 130 may not be limited to determination based on a fixed threshold, which may be replaced with an adaptive determination algorithm. For example, by dynamically adjusting the determination criterion according to the user's behavior patterns or time zone, it is possible to perform the determination that is more suitable for the situation.

Furthermore, the entire apparatus may be replaced with cloud-based processing. Performing feature extraction of ornaments and matching degree calculation on a cloud server, reduces a processing load of a main body of the HMD 20, enabling more advanced analysis and matching/collation against a large-scale database.

These replacements make it possible to expand the system's performance and scope of application, while maintaining the fundamental effects of the present example embodiment.

### Fourth Example Embodiment

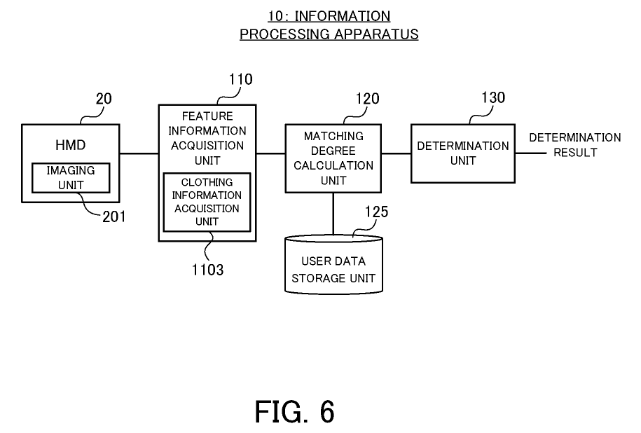

A fourth information processing apparatus 10 will be described with reference to FIG. 6. The fourth information processing apparatus 10 partially differs from the first to third information processing apparatuses 10 described above in its configuration and operation, and may be the same as the first to third information processing apparatuses 10 in the other parts. Therefore, the following description details only parts differing from the already described example embodiments, omitting a redundant description for other overlapping parts as appropriate.

### Functional Configuration

First, with reference to FIG. 6, a functional configuration of the fourth information processing apparatus 10 will be described. FIG. 6 is a block diagram illustrating the functional configuration of the fourth information processing apparatus. In FIG. 6, the same reference numerals are used for the same components as those illustrated in FIG. 2.

In FIG. 6, the fourth information processing apparatus 10 includes, as components for realizing its functions, the HMD 20, the feature information acquisition unit 110, the matching degree calculation unit 120, the user data storage apparatus 125, and the determination unit 130. Especially, the feature information acquisition unit 110 in the fourth information processing apparatus 10 includes a clothing information acquisition unit 1103.

The clothing information acquisition unit 1103 is configured to acquire information about clothing (e.g., clothes that the user is wearing, etc.) captured around the hand or arm, from the captured image obtained by the imaging unit 201. The feature information acquisition unit 110 acquires the information about the clothing acquired by the clothing information acquisition unit 1103, as the feature information about the hand or arm. The clothing information acquisition unit 1103 may perform image processing on the captured image to detect the clothing that the user is wearing, and extract a feature/characteristic such as its pattern and color.

### Technical Effect

Next, a technical effect obtained by the fourth information processing apparatus 10 will be described.

As described in FIG. 6, in the fourth information processing apparatus 10, the information about the clothing in the captured image is acquired as the feature information. This enables high-speed and accurate determination of whether the hand or arm belongs to the user, by utilizing the information about the clothing, which is a simple yet effective feature.

More specifically, the use of the clothing that the user is wearing as the feature information allows a more highly personal feature/characteristic to be used as the determination criterion. The clothing reflects personal preferences and habits, making it a more distinctive feature for identifying an individual than the shape or color of the hand or arm. This enables the identification of the user's own hand or arm with higher accuracy.

In the fourth information processing apparatus 10, it is considered that there may be the same situations as those described in the third example embodiment above. Regarding this, the fourth processing apparatus 10 is also configured to perform the same additional operations as those described in the third example embodiment.

Furthermore, the components of the fourth processing apparatus 10 may be replaced in the same manner as described in the third example embodiment above.

### Fifth Example Embodiment

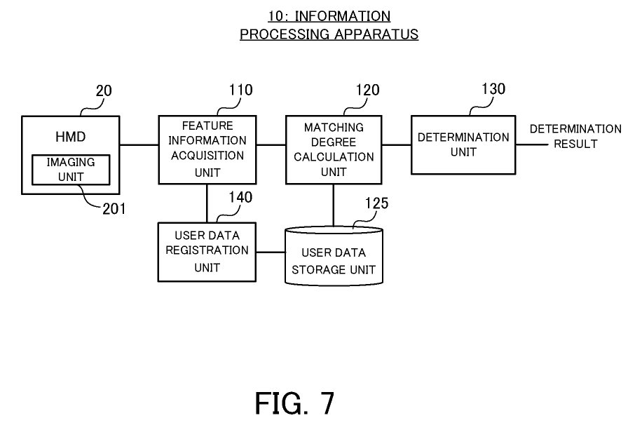

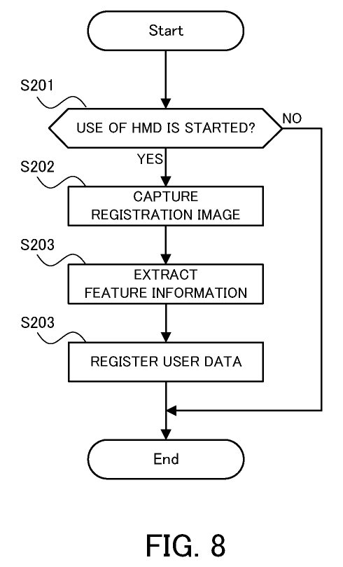

A fifth processing apparatus 10 will be described with reference to FIGS. 7 and 8. The fifth information processing apparatus 10 partially differs from the first to fourth information processing apparatuses 10 described above in its configuration and operation, and may be the same as the first through fourth information processing apparatus 10 in the other parts. Therefore, the following description details only parts differing from the already described example embodiments, omitting a redundant description for other overlapping parts as appropriate.

### Functional Configuration

First, with reference to FIG. 7, a functional configuration of the fifth information processing apparatus 10 will be described. FIG. 7 is a block diagram illustrating the functional configuration of the fifth information processing apparatus. Note that in FIG. 7, the same reference numerals are used for the same components as those illustrated in FIG. 2.

In FIG. 7, the fifth information processing apparatus 10 includes, as components for realizing its functions, the HMD 20, the feature information acquisition unit 110, the matching degree calculation unit 120, the user data storage unit 125, the determination unit 130, and a user data registration unit 140. That is, the fifth information processing apparatus 10 further includes the user data registration unit 140 in addition to the configuration described in the first example embodiment (see FIG. 2). Note that the user data registration unit 140 may be a processing block realized by the aforementioned processor 11 (see FIG. 1).

The user data registration unit 140 operates when the use of the HMD 20 is started, and registers the feature information about the user's hand or arm. For example, the user data registration unit 140 registers the feature information about the user's hand or arm, using an image captured when the use of the HMD 20 is started (hereinafter referred to as a “registration image” as appropriate). The user data registration unit 140 may perform an operation of storing, in the user data storage unit 125, the feature information acquired by the feature information acquisition unit 110 from the registration image.

### User Data Registration Operation

Next, with reference to FIG. 8, a flow of a user data registration operation performed by the fifth information processing apparatus 10 (i.e., an operation when the user data registration unit 140 registers the user's feature information) will be described. FIG. 8 is a flowchart illustrating the flow of the user data registration operation by the fifth information processing apparatus.

As illustrated in FIG. 8, when the user data registration operation is performed, the user data registration unit 140 first determines whether or not the use of the HMD 20 is started (Step S201). In a case where the use of the HMD 20 is not started (Step S201: NO), the subsequent processing is omitted, and a series of operation steps may be ended.

On the other hand, in a case where the use of the HMD 20 is started (Step S201: YES), the imaging unit 201 captures the registration image. Then, the feature information extraction unit 110 extracts the feature information about the user of the HMD 20 from the registration image (Step S203).

Subsequently, the user data registration unit 140 registers, in the user data storage unit 125, the feature information extracted from the registration image, as the registered feature information (Step S203). The registered feature information registered here is later read by the matching degree calculation unit 120 and is used when a matching degree with acquired registration information is calculated (e.g., see Step S103 in FIG. 3).

The user data registration operation described above may be performed during calibration of the HMD 20. During calibration, an instruction may be outputted to the user of the HMD 20 such that the hand or arm is located within an image capture range of the imaging unit 201. For example, a message such as “Please open your hands and reach your arms out in front” may be displayed to the user of the HMD 20.

Furthermore, the user data registration operation may be performed in timing other than the calibration. For example, the user of the HMD20 may photograph their own hand or arm using a smartphone or a similar device, and the image may be used as the registration image to register registration information. The user data registration operation may also be performed during an initial startup (i.e., setup) of the HMD20. Alternatively, the user data registration operation may be performed during a registration phase provided after the calibration.

### Technical Effect

Next, a technical effect obtained by the fifth information processing apparatus 10 will be described.

As described in FIGS. 7 and 8, in the fifth information processing apparatus 10, the registered feature information is registered when the use of the HMD 20 is started. This allows the user's feature information to be registered in appropriate timing, making it possible to appropriately perform the subsequent determination operation (i.e., the operation of determining whether the hand or arm in the captured image belongs to the user).

### Sixth Example Embodiment

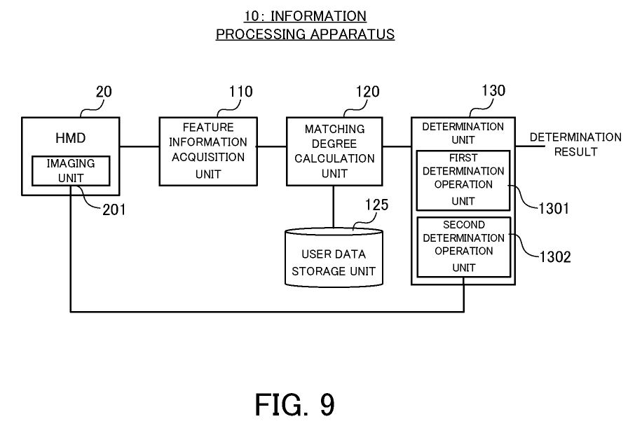

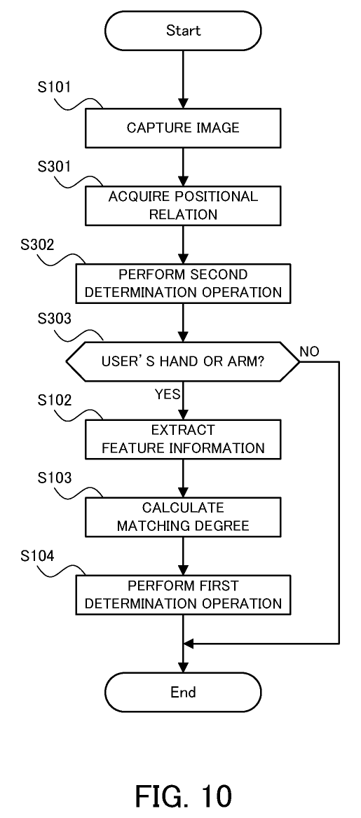

A sixth information processing apparatus 10 will be described with reference to FIGS. 9 and 10. The sixth information processing apparatus 10 partially differs from the first to fifth information processing apparatuses 10 described above in its configuration and operation, and may be the same as the first to fifth information processing apparatuses 10 in the other parts. Therefore, the following description details only parts differing from the already described example embodiments, omitting a redundant description for other overlapping parts as appropriate.

### Functional Configuration

First, with reference to FIG. 9, a functional configuration of the sixth information processing apparatus 10 will be described. FIG. 9 is a block diagram illustrating the functional configuration of the sixth information processing apparatus. In FIG. 9, the same reference numerals are used for the same components as those illustrated in FIG. 2.

In FIG. 9, the fourth information processing apparatus 10 includes, as components for realizing its functions, the HMD 20, the feature information acquisition unit 110, the matching degree calculation unit 120, the user data storage unit 125, and the determination unit 130. Especially, the determination unit 130 in the sixth processing apparatus 10 includes a first determination operation unit 1301 and a second determination operation unit 1302.

The first determination operation unit 1301 is configured to perform an operation of determining, based on the matching degree calculated by the matching degree calculation unit 120, whether or not the hand or arm in the captured image belongs to the user of the HMD 20 (i.e., the first determination operation). That is, the first determination operation unit 1301 in the sixth processing apparatus 10 has the same function as that of the determination unit 130 in the first processing apparatus 10.

The second determination operation unit 1302 is configured to perform a second determination operation before the first determination operation unit 1301 performs the first determination operation. The second determination operation is an operation of determining, based on a positional relation between a torso part and the hand or arm in the captured image, whether or not the hand or arm in the captured image belongs to the user. For example, in the case of the user's hand or arm, it should extend from the torso part in the captured image. Therefore, the second determination operation unit 1302 may determine whether there is a hand or arm in a range in which it naturally extends from the torso part. In this case, the second determination operation unit 1302 may determine that a hand or arm extending from the torso part belongs to the user. On the other hand, the second determination operation unit 1302 may determine that a hand or arm not extending from the torso part (e.g., a hand or arm extending from another part) does not belong to the user.

### Flow of Operation

Next, with reference to FIG. 10, a flow of operation in the sixth information processing apparatus 10 will be described. FIG. 10 is a flowchart illustrating the flow of operation in the sixth information processing apparatus. Note that in FIG. 10, the same reference numerals are used for the same steps as those described in FIG. 3.

As illustrated in FIG. 10, when the operation of the sixth information processing apparatus 10 is started, the imaging unit 201 in the HMD 20 first captures the captured image (Step S101). The captured image here is captured as an image including not only the hand or arm of the user of the HMD 20, but also the user's torso part.

Then, the second determination operation unit 1302 acquires the positional relation between the torso part and the hand or arm in the captured image (step S301). Then, the second determination operation unit 1302 performs the second determination operation (Step S302). That is, the second determination operation unit 1302 determines whether or not the hand or arm in the captured image belongs to the user of the HMD 20, based on the positional relation between the torso part and the hand or arm in the captured image.

In the second determination operation, in a case where it is determined that the hand or arm in the captured image does not belong to the user of the HMD20 (Step S303: NO), the subsequent processing may be omitted. That is, without even performing the first determination operation, the operation is ended when it is determined that the hand or arm in the captured image does not belong to the user of the HMD20 (i.e., belongs to another person).

On the other hand, in a case where it is determined that the hand or arm in the captured image belongs to the user of HMD 20 (Step S303: YES), the feature information acquisition unit 110 extracts the feature information about the hand or arm, from the captured image obtained by the imaging unit 201 (Step S102). Here, the captured image may be one newly captured after the second determination operation.

Then, the matching degree calculation unit 120 calculates the matching degree between the acquired feature information obtained by the feature information acquisition unit 110 and the registered feature information read from the user data storage unit 125 (Step S103). Then, the determination unit 130 performs the first determination operation (Step S104). That is, the determination unit 130 determines whether or not the hand or arm in the captured image belongs to the user of the HMD 20, based on the matching degree calculated by the matching degree calculation unit 120.

### Technical Effect

Next, a technical effect obtained by the sixth information processing apparatus 10 will be described.

As described in FIGS. 9 and 10, in the sixth information processing apparatus 10, it is first determined by the second determination operation whether or not the hand or arm in the captured image belongs to the user. Then, in a case where it is determined in the second determination operation that the hand or arm belongs to the user, the first determination operation is performed. This makes it possible to determine whether or not the hand or arm belongs to the user, more appropriately, in comparison with a case of performing only the first determination operation.

Specifically, first, it is possible to exclude at an early stage the hands or arms that clearly do not belong to the user by first determining the positional relation between the user's torso part and the hand or arm through the second determination operation. This reduces the number of executions of the first determination operation, thereby reducing the overall processing load on the apparatus.

Second, performing two-stage determination including the second determination operation and the first determination operation, improves the determination accuracy. Performing coarse filtering in the second determination operation and detailed feature information comparison in the first determination operation, reduces the risk of erroneous determination. For example, there is a case where the hand or arm extends from around the user's body, but does not belong to the user. In such a case, the first determination operation is effective. Therefore, the configuration that the first determination operation is performed only in response to a success in the second determination operation, may also adapt to a case where another person's arm extends from around the user's body.

Third, even when there is another person around the user, it is possible to reliably prevent unintended operation by the other person's hand or arm. This significantly enhances the reliability and safety in the operation of the HMD 20.

As described above, the sixth information processing apparatus 10 provides s excellent solutions offering multifaceted advantages, including processing efficiency, determination accuracy, and operational reliability.

In the sixth information processing apparatus 10, the components may be replaced as follows.

The imaging unit 201 may not be limited to a single camera, which may be replaced with a stereo camera system including a combination of a plurality of cameras. This makes it possible to acquire more accurate depth information, enabling more precise determination of the positional relation between the torso part and the hand or arm.

The feature information acquisition unit 110 may be combined with a hardware sensor such as a depth sensor and an infrared sensor, in addition to image processing software. This enables acquisition of more diverse feature information and improves the determination accuracy.

The matching degree calculation unit 120 may replace a simple feature information comparison algorithm with an advanced comparison system using a machine learning model. For example, the use of a convolutional neural network (CNN) enables the recognition of more complex feature patterns and improves the accuracy of calculation of the matching degree.

The determination unit 130 may replace a rule-based determination logic with a probabilistic model such as a Bayesian network that performs probabilistic inference. This enables flexible determination that takes uncertainty into account, and enables more adaptive determination in various situations.

Furthermore, it is possible to change the order of the second determination operation and the first determination operation, or perform them in parallel. For example, it is possible to improve processing speed by changing to a method where both of the determinations are simultaneously performed and their results are integrated for final determination.

These replacements expand the performance and scope of application of the sixth information processing apparatus 10, enabling the construction of a more advanced and flexible system.

The example embodiments described above are provided to facilitate the understanding of the present disclosure, and are not intended to limit the disclosure. Therefore, various modifications to these example embodiments are possible, or the components in the example embodiments may be combined as appropriate for implementation.

For example, the information about the hand or arm described in the first example embodiment, the information about the color described in the second example embodiment, the feature information about the ornament described in the third example embodiment, and the feature information about the clothing described in the fourth example embodiment, may be used in appropriate combinations. This enables more multifaceted determination, and further improves the determination accuracy.

Furthermore, the configuration described in the fifth example embodiment that the registered feature information is registered when the use is started, may be combined with those described in the other example embodiments. This improves the determination accuracy in each example embodiment.

Additionally, the two-stage determination method described in the sixth example embodiment, may be combined with those described in the other example embodiments. This improves the processing efficiency and the determination accuracy in each example embodiment.

As described above, by combining the features of each example embodiment as appropriate, it is possible to construct a more advanced and flexible recognition system for the hand or arm.

It goes without saying that the present disclosure is not limited to the above example embodiments and may be appropriately modified within the scope of the intended purpose.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### SUPPLEMENTARY NOTES

The example embodiments described above may be further described as, but not limited to, the following Supplementary Notes below.

### Supplementary Note 1

An information processing apparatus according to Supplementary Note 1 is an information processing apparatus including: an acquisition unit that acquires feature information about a hand or arm, from a captured image of a hand or arm obtained by an imaging unit of a head-mounted display; a calculation unit that calculates a matching degree between the feature information about a hand or arm of a user of the head-mounted display registered in advance and the feature information acquired by the acquisition unit; and a determination unit that performs a first determination operation of determining, based on the matching degree, whether or not the hand or arm in the captured image is the hand or arm of the user.

### Supplementary Note 2

An information processing apparatus according to Supplementary Note 2 is the information processing apparatus according to Supplementary Note 1, wherein the feature information is information about a color of the hand or arm.

### Supplementary Note 3

An information processing apparatus according to Supplementary Note 3 is the information processing apparatus according to Supplementary Note 1 or 2, wherein the feature information is information about an ornament on the hand or arm.

### Supplementary Note 4

An information processing apparatus according to Supplementary Note 4 is the information processing apparatus according to any one of Supplementary Notes 1 to 3, wherein the feature information is information about clothing that a user is wearing.

### Supplementary Note 5

An information processing apparatus according to Supplementary Note 5 is the information processing apparatus according to any one of Supplementary Notes 1 to 4, wherein the feature information about the hand or arm of the user is registered in response to a start to use the head-mounted display.

### Supplementary Note 6

An information processing apparatus according to Supplementary Note 6 is the information processing apparatus according to any one of Supplementary Notes 1 to 5, wherein the determination unit performs a second determination operation of determining, based on a positional relation between a torso part and the hand or arm in the captured image, whether or not the hand or arm in the captured image is the hand or arm of the user, and the determination unit performs the second determination operation, instead of the first determination operation, in a case where the hand or arm in the captured image is determined to be the hand or arm of the user in the first determination operation, within a predetermined time.

### Supplementary Note 7

An information processing apparatus according to Supplementary Note 7 is the information processing apparatus according to any one of Supplementary Notes 1 to 6, wherein the determination unit performs a second determination operation of determining, based on a positional relation between a torso part and the hand or arm in the captured image, whether or not the hand or arm in the captured image is the hand or arm of the user, and the determination unit performs the first determination operation in a case where the hand or arm in the captured image is determined to be the hand or arm of the user in the second determination operation.

### Supplementary Note 8

An information processing method according to Supplementary Note 8 is an information processing method that is executed by at least one computer, the information processing method including: acquiring feature information about a hand or arm, from a captured image of a hand or arm obtained by an imaging unit of a head-mounted display; calculating a matching degree between the feature information about a hand or arm of a user of the head-mounted display registered in advance and the feature information acquired; and performing a first determination operation of determining, based on the matching degree, whether or not the hand or arm in the captured image is the hand or arm of the user.

### Supplementary Note 9

A computer program according to Supplementary Note 9 is a computer program that allows at least one computer to execute an information processing method, the information processing method including: acquiring feature information about a hand or arm, from a captured image of a hand or arm obtained by an imaging unit of a head-mounted display; calculating a matching degree between the feature information about a hand or arm of a user of the head-mounted display registered in advance and the feature information acquired; and performing a first determination operation of determining, based on the matching degree, whether or not the hand or arm in the captured image is the hand or arm of the user.

### Supplementary Note 10

A non-transitory recording medium according to Supplementary Note 10 is a non-transitory recording medium on which a computer program that allows at least one computer to execute an information processing method is recorded, the information processing method including: acquiring feature information about a hand or arm, from a captured image of a hand or arm obtained by an imaging unit of a head-mounted display; calculating a matching degree between the feature information about a hand or arm of a user of the head-mounted display registered in advance and the feature information acquired; and performing a first determination operation of determining, based on the matching degree, whether or not the hand or arm in the captured image is the hand or arm of the user.

### Supplementary Note 11

An information processing system according to Supplementary Note 11 is an information processing system including: a head-mounted display; an acquisition unit that acquires feature information about a hand or arm, from a captured image of a hand or arm obtained by an imaging unit of the head-mounted display; a calculation unit that calculates a matching degree between the feature information about a hand or arm of a user of the head-mounted display registered in advance and the feature information acquired by the acquisition unit; a determination unit that performs a first determination operation of determining, based on the matching degree, whether or not the hand or arm in the captured image is the hand or arm of the user; and a receiving unit that receives an input operation to the head-mounted display, based on a determination result of the determination unit.

The present disclosure is not limited to the above-described examples and is allowed to be changed, if desired, without departing from the essence or spirit of the invention which can be read from the claims and the entire specification. An information processing apparatus, an information processing method, a computer program, and a non-transitory recording medium with such changes, are also included in the technical concepts of the present disclosure.

### DESCRIPTION OF REFERENCE NUMERALS

10 Information processing apparatus

11 Processor

12 RAM

13 ROM

14 Storage apparatus

15 Input apparatus

16 Output apparatus

17 Data bus

20 Head-mounted display

201 Imaging unit

110 Feature information acquisition unit

1101 Color information acquisition unit

1102 Ornament information acquisition unit

1103 Clothing information acquisition unit

120 Matching degree calculation unit

125 User data storage unit

130 Determination unit

1301 First determination operation unit

1302 Second determination operation unit

140 User data registration unit

What is claimed is:

1. An information processing apparatus comprising:
at least one memory that is configured to store instructions; and
at least one processor that is configured to execute the instructions to:
acquire feature information about a hand or arm, from a captured image of a hand or arm obtained by an imaging unit of a head-mounted display;
calculate a matching degree between feature information about a hand or arm of a user of the head-mounted display registered in advance and the acquired feature information acquired; and
perform a first determination operation of determining, based on the matching degree, whether or not the hand or arm in the captured image is the hand or arm of the user.

2. The information processing apparatus according to claim 1, wherein
the acquired feature information is information about a color of the hand or arm.

3. The information processing apparatus according to claim 1, wherein
the acquired feature information is information about an ornament on the hand or arm.

4. The information processing apparatus according to claim 1, wherein
the acquired feature information is information about clothing that a user is wearing.

5. The information processing apparatus according to claim 1, wherein
the acquired feature information about the hand or arm of the user is registered in response to a start to use the head-mounted display.

6. The information processing apparatus according to claim 1, wherein the at least one processor is configured to execute the instructions to:
perform a second determination operation of determining, based on a positional relation between a torso part and the hand or arm in the captured image, whether or not the hand or arm in the captured image is the hand or arm of the user, and
perform the second determination operation, instead of the first determination operation, in a case where the hand or arm in the captured image is determined to be the hand or arm of the user in the first determination operation, within a predetermined time.

7. The information processing apparatus according to claim 1, wherein the at least one processor is configured to execute the instructions to:
perform a second determination operation of determining, based on a positional relation between a torso part and the hand or arm in the captured image, whether or not the hand or arm in the captured image is the hand or arm of the user, and
perform the first determination operation in a case where the hand or arm in the captured image is determined to be the hand or arm of the user in the second determination operation.

8. An information processing method that is executed by at least one computer, the information processing method comprising:
acquiring feature information about a hand or arm, from a captured image of a hand or arm obtained by an imaging unit of a head-mounted display;
calculating a matching degree between feature information about a hand or arm of a user of the head-mounted display registered in advance and the acquired feature information acquired; and
performing a first determination operation of determining, based on the matching degree, whether or not the hand or arm in the captured image is the hand or arm of the user.

9. A non-transitory recording medium on which a computer program that allows at least one computer to execute an information processing method is recorded, the information processing method including:
acquiring feature information about a hand or arm, from a captured image of a hand or arm obtained by an imaging unit of a head-mounted display;
calculating a matching degree between feature information about a hand or arm of a user of the head-mounted display registered in advance and the acquired feature information acquired; and
performing a first determination operation of determining, based on the matching degree, whether or not the hand or arm in the captured image is the hand or arm of the user.
